(19) United States
(12) Patent Application Publication
(10) Pub. No.: US 2019/0384881 A1
(43) Pub. Date: Dec. 19, 2019

(54) Device for Simulating a Modular Direct-Voltage Source

(71) Applicant: Bayerische Motoren Werke Aktiengesellschaft, Muenchen (DE)

(72) Inventors: Jens LEICKERT, Poing (DE); Steffen ROTHE, Dresden (DE); Brigitte SCHWUCHOW, Olching (DE); Rondehl SLATER, Muenchen (DE); Vanessa VOGGESER, Penzberg (DE)

(21) Appl. No.: 16/557,233

(22) Filed: Aug. 30, 2019

Related U.S. Application Data
(63) Continuation of application No. PCT/EP2018/054484, filed on Feb. 23, 2018.

(30) Foreign Application Priority Data
Mar. 2, 2017 (DE) 10 2017 203 374.6

(51) Int. Cl. G06F 17/50; G05F 1/625; G05F 1/56

(52) U.S. Cl. CPC G06F 17/5036; G05F 1/56; G05F 1/625

(57) ABSTRACT

A simulation device for simulating a direct-voltage source having a plurality of partial voltage sources includes at least one simulation module having a module voltage source designed to provide a module voltage at two outer measurement points of the simulation module, and a voltage divider, which divides the module voltage into N−1 intermediate potentials at N−1 intermediate points, with N>1. The simulation module also comprises N−1 operational amplifiers, which are designed to convert the N−1 intermediate potentials into N−1 partial potentials at N−1 inner measurement points of the simulation module. The N−1 inner measurement points are enclosed by the two outer measurement points in order to provide N partial voltages between N pairs of adjacent measurement points of the N+1 measurement points in order to simulate N partial voltage sources.

### CROSS REFERENCE TO RELATED APPLICATIONS

This application is a continuation of PCT International Application No. PCT/EP2018/054484, filed Feb. 23, 2018, which claims priority under 35 U.S.C. § 119 from German Patent Application No. 10 2017 203 374.6, filed Mar. 2, 2017, the entire disclosures of which are herein expressly incorporated by reference.

### BACKGROUND AND SUMMARY OF THE INVENTION

The invention relates to a device for simulating modular DC voltage sources, which comprise a multiplicity of partial voltage sources connected in series.

Modular DC voltage sources are used for supplying energy in various different applications. For example, batteries having a multiplicity of storage cells are used to store electrical energy for the operation of an electric drive machine of a vehicle. Fuel cell stacks having a multiplicity of fuel cells can be used to generate electrical energy for the operation of an electric drive machine of a vehicle. Furthermore, a solar device having a series circuit composed of a multiplicity of solar modules can be used to generate electrical energy. Such systems are referred to in this document as modular DC voltage sources having a series circuit of partial voltage sources.

A modular DC voltage source typically comprises a monitoring unit (for example, a voltage monitoring electronics system), by way of which the operation of the individual partial voltage sources can be monitored and/or controlled. The present document deals with the technical problem of providing a device for simulating a modular DC voltage source, by way of which device, in particular, the monitoring unit of a modular DC voltage source can be tested in an efficient, safe and reliable manner.

The problem is solved by the features of the independent patent claim. Advantageous embodiments are described, inter alia, in the dependent claims. Reference is made to the fact that additional features of a patent claim dependent on an independent patent claim, without the features of the independent patent claim or only in combination with some of the features of the independent patent claim, may form a separate invention, independent of the combination of all of the features of the independent patent claim, which invention may form the subject matter of an independent claim, of a divisional application or of a subsequent application. This applies in the same way to the technical teaching described in the description, which teaching may form an invention independent of the features of the independent patent claims.

According to one aspect, a simulation device for simulating a DC voltage source, in particular for simulating an electrochemical DC voltage source, is described. The DC voltage source in this case comprises a multiplicity of partial voltage sources. For example, an electrical energy store typically comprises a multiplicity of battery cells as partial voltage sources, wherein in each case N battery cells may be combined in storage modules (for example N=8), and wherein an electrical energy store, in particular a high-voltage store for a vehicle, can comprise a plurality of storage modules connected in series. As an alternative, a fuel cell stack can have a multiplicity of fuel cells as partial voltage sources.

The simulation device comprises at least one simulation module. The simulation module can be used to simulate one or more DC voltage source modules having N partial voltage sources (for example, a storage module of an electrical energy store having N battery cells). A plurality of simulation modules (which are arranged, for example, in series with one another) can also possibly be used to simulate a DC voltage source module. The simulation module comprises a module voltage source, which is configured to provide a module voltage at two external measurement points of the simulation module. In this case, the module voltage can correspond to the voltage that is provided by the DC voltage source module, for example, as a rated value.

The module voltage source can be configured to provide a regulated module voltage (for example, by means of a voltage regulator, such as a low drop voltage regulator (LDO)). Furthermore, the module voltage source can comprise a voltage converter, which is configured to generate the module voltage on the basis of a supply voltage (for example, a 230 V or a 130 V grid voltage). The module voltage source can in this case have a relatively low output impedance such that the module voltage is substantially independent of the current provided by the module voltage source up to a predefined current intensity.

The simulation module further comprises a voltage divider, which is configured to divide the module voltage into N−1 intermediate potentials at N−1 intermediate points, where N>1. Typically, N>3, 5, 7 or 10 for a simulation module. The voltage divider can comprise a series circuit of N resistors, wherein the series circuit of N resistors is arranged in parallel with the module voltage source. An intermediate point of the voltage divider can then correspond to a contact point between two directly adjacent resistors of the N resistors. In particular, the N−1 intermediate points can correspond to the N−1 contact points between the respective directly adjacent resistors. The module voltage can be divided by way of a voltage divider in order to provide partial voltages for N partial voltage sources that are to be simulated.

To provide the partial voltages for the N partial voltage sources that are to be simulated, the simulation module comprises N−1 operational amplifiers or differential amplifiers, which are configured to convert the N−1 intermediate potentials to corresponding N−1 partial potentials at N−1 internal measurement points of the simulation module. The N−1 internal measurement points are in this case surrounded by the two external measurement points so that the simulation module comprises a total of N+1 measurement points. N partial voltages can then be provided between N pairs of (directly) adjacent measurement points of the N+1 measurement points in order to simulate N partial voltage sources. In this case, the sum of the N partial voltages typically corresponds to the module voltage. By way of example, the partial voltages lie in a voltage range between 3 V and 5 V (for example, to simulate battery cells, such as lithium ion cells) or between 0.5 V and 6 V (for example, to simulate solar cells and/or electrochemical cells).

By using a module voltage source in combination with N−1 operational amplifiers, N partial voltages can be provided in an efficient and reliable manner to simulate the N partial voltage sources of a DC voltage source module. The N partial voltages can be provided to a monitoring unit for the DC voltage source to simulate the behavior of the partial voltage sources of a real DC voltage source.

A positive input of an operational amplifier can be coupled (possibly directly) to an intermediate point. Furthermore, an output of the operational amplifier can be coupled (possibly directly) to an internal measurement point. Moreover, the output of the operational amplifier can be coupled (possibly directly) to a negative input of the operational amplifier. Said arrangement can be used for the N−1 operational amplifiers of a simulation module. Stable partial potentials can therefore be provided in an efficient manner at the N−1 internal measurement points. In particular, the output impedance between the N pairs of (directly) adjacent measurement points can thus be reduced to provide stable partial voltages to simulate the partial voltage sources.

The N−1 operational amplifiers can be supplied with electrical energy by way of the module voltage source such that an efficient simulation module can be provided.

The voltage divider can be configured to at least partly change the N−1 intermediate potentials. In particular, a division of the module voltage over the N−1 intermediate potentials can be changed. This can be achieved, for example, by using one or more resistors with adjustable resistance values. By changing at least one of the N−1 intermediate potentials, at least one of the partial voltages can be changed. Different states (for example, different states of charge) of different partial voltage sources (for example, of different battery cells) can thus be simulated in a flexible manner.

The simulation device can comprise at least two simulation modules, which are connected in series. DC voltage sources having a plurality of modules can thus be simulated. Two (directly) adjacent simulation modules can in this case be coupled to one another at a joint external measurement point. This is made possible, in particular, by virtue of the fact that the potentials at the external measurement points are provided not by means of an operational amplifier but directly from the respective module voltage source. An efficient series circuit of simulation modules is therefore made possible by the design of a simulation module described in this document.

According to a further aspect, a test arrangement for testing a monitoring unit for a DC voltage source, in particular for an electrochemical DC voltage source is described. The test arrangement comprises the monitoring unit, which is configured to monitor and/or to control a DC voltage source on the basis of a multiplicity of measurement voltages for a corresponding multiplicity of partial voltage sources of the DC voltage source. The monitoring unit is therefore configured to detect a multiplicity of measurement voltages with respect to a corresponding multiplicity of partial voltage sources.

The test arrangement further comprises a simulation device described in this document for providing the multiplicity of partial voltages. The test arrangement also comprises lines, which are configured to provide a multiplicity of partial voltages (as measurement voltages) to the monitoring unit. A reliable and efficient test of a monitoring unit is therefore made possible.

It should be borne in mind that the devices and systems described in this document are able to be used both on their own and in combination with other devices and systems described in this document. Furthermore, any aspects of the devices and systems described in this document may be combined with one another in a wide variety of ways. In particular, the features of the claims may be combined with one another in a wide variety of ways.

Other objects, advantages and novel features of the present invention will become apparent from the following detailed description of one or more preferred embodiments when considered in conjunction with the accompanying drawings.

### BRIEF DESCRIPTION OF THE DRAWINGS

The invention is described in more detail below with reference to exemplary embodiments, in which

FIG. 1 shows an exemplary test arrangement for testing the monitoring unit of a modular DC voltage source.

FIG. 2 shows a simulation module for a DC voltage source module.

FIG. 3 shows a simulation device for a DC voltage source having a plurality of DC voltage source modules connected in series.

### DETAILED DESCRIPTION OF THE DRAWINGS

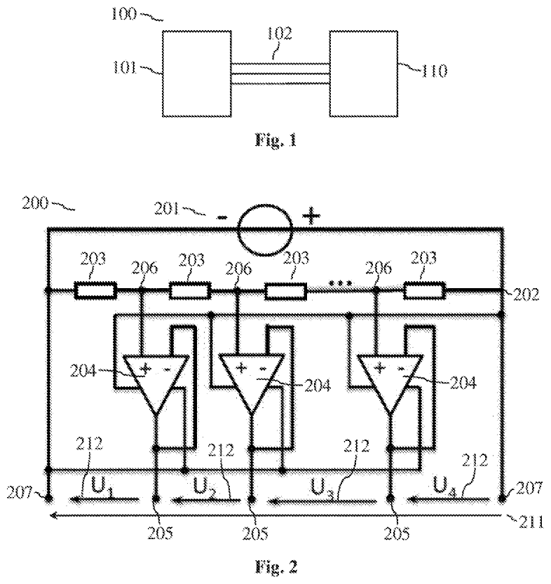

As presented at the beginning, the present document deals with the simulation of a DC voltage source, in particular in order to be able to test the monitoring unit of a DC voltage source in an efficient and precise manner. In this connection, FIG. 1 shows a test arrangement 100 having a monitoring unit 101 and a simulation device 110 for a DC voltage source. During operation, the monitoring unit 101 is connected via measurement lines 102 to different measurement points within the DC voltage source that is to be monitored and/or that is to be controlled. For example, the output voltage of the individual partial voltage sources of the DC voltage source can be detected via the measurement lines 102 in order to be able to monitor the state of the individual partial voltage sources.

The simulation device 110 can have measurement points for the individual measurement lines 102. Furthermore, the simulation device 110 can be configured to provide simulated partial voltages for individual partial voltage sources at the measurement points.

FIG. 2 shows an exemplary simulation module 200 for a DC voltage source module having a multiplicity of partial voltage sources. The simulation device 110 for a DC voltage source can have one or more such simulation modules 200. The simulation module 200 comprises a module voltage source 201, which is configured to provide a (regulated) module or total voltage 211. The module voltage 211 can in this case correspond to the rated voltage of a DC voltage source module that is to be simulated.

Furthermore, the simulation module 200 comprises a voltage divider 202, which is configured to divide the module voltage 211 into a plurality of (unregulated) intermediate voltages. In the example illustrated in FIG. 2, the voltage divider 202 comprises a series circuit of electrical resistors 203, wherein in each case an (unregulated) intermediate potential is provided at the contact points or intermediate points 206 between two resistors 203. When identical resistance values are used for the N resistors 203 of the voltage divider 202, the module voltage 211 can be divided into N−1 identical (unregulated) intermediate potentials.

The simulation module 200 also comprises one or more fed back operational amplifiers 204 (in particular N−1 operational amplifiers 204) in order to provide (regulated) partial voltages 212 between the measurement points 205, 207 based on the (unregulated) intermediate potentials at the intermediate points 206. In particular, each contact point 206 between two resistors 203 can be led to an internal measurement point 205 via an operational amplifier 204, wherein the output of an operational amplifier 204 is fed back to a (negative) input of the operational amplifier 204. N (regulated) partial voltages 212 can thus be provided at the measurement points 205, 207, said partial voltages being substantially independent of the current that flows at the individual measurement points 205, 207.

By way of the simulation module 200 illustrated in FIG. 2, a total of N partial voltages 212 can therefore be provided by using N−1 operational amplifiers 204 between pairs of adjacent measurement points 205, 207 of the N+1 measurement points 205, 207. In this case, the pairs of adjacent measurement points 205, 207 in each case have a relatively low output impedance such that stable partial voltages 212 can be provided for different current intensities.

The external measurement points 207 of the simulation module 200 (between which measurement points the module voltage 211 is applied) have the output impedance of the module voltage source 201 such that stable (regulated) partial voltages 212 (U₁ and U₄ in FIG. 2) can be provided at the external measurement points 207 even without using fed back operational amplifiers 204 for the external measurement points 207.

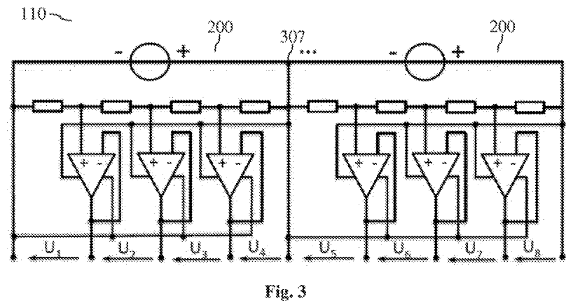

The use of N−1 operational amplifiers 204 for setting the potentials at the N−1 internal measurement points 205 of the simulation module 200 in combination with the use of a module voltage source 201 for providing a module voltage 211 between the two external measurement points 207, which surround the N−1 internal measurement points 205, makes it possible to cascade or scale simulation modules 200 efficiently in order to provide a simulation device 110 for a DC voltage source that comprises a plurality of cascaded DC voltage source modules (for example, a series circuit of battery modules, wherein each battery module comprises a multiplicity of storage cells). This is illustrated in FIG. 3. In particular, FIG. 3 shows how two simulation modules 200 can be coupled to one another at an external measurement point 207, 307 in order to be able to simulate a series circuit of DC voltage source modules.

A scalable circuit for simulating DC voltage sources connected in series, such as electrical batteries, fuel cell stacks or solar modules, is therefore described. FIG. 2 in this case shows a simulation module 200 having voltage generators connected in series and having a relatively low output impedance. A voltage generator can in this case comprise a differential amplifier 204, which is operated as a voltage follower or impedance converter. On the input side, a target voltage is set for the differential amplifier 204 (that is to say the intermediate potential) by way of a voltage divider 202. The supplying module voltage source 201 does not typically require adjustment by way of a separate voltage follower circuit on account of the low output impedance and itself offers a defined partial voltage within the series circuit. The supply of power to the N−1 differential or operational amplifiers 204 is effected directly by the module voltage 211.

FIG. 3 illustrates scaling of the simulation module 200 from FIG. 2. The scaling is effected by way of a series circuit of the individual module voltage sources 201 of the individual simulation modules 200.

As already presented above, the module voltage 211 of a simulation module 200 is not only used to provide a joint basic potential and to supply power to the operational amplifiers 205. The module voltage source 201 itself further provides the last voltage level to be generated at one or both external measurement points 207 (without using an operational amplifier 204). The simulation module 200 thus produced can thereby be connected in series, that is to say scaled, in an effective manner.

The voltage divider 202 can be configured to change the individual intermediate potentials generated from the module voltage 211. To this end, for example, the resistance values of the individual resistors 203 can be at least partly changed with respect to one another. Different states of individual partial voltage sources (for example, storage cells or fuel cells) can thus be simulated.

By way of the simulation device 110 described in this document, the outlay for the development and in particular for the testing of a monitoring unit 101 for a DC voltage source can be reduced. In this case, the development and/or the tests can be carried out on the simulation device 110 instead of on a battery, a fuel cell stack or a solar module. The simulation device 110 can be de-energized when required, which is not possible in electrochemical DC voltage sources, with the result that safe handling is made possible.

The present invention is not restricted to the exemplary embodiments shown. In particular, it should be borne in mind that the description and the figures are intended only to elucidate the principle of the proposed methods, devices and systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A simulation device for simulating a DC voltage source, in particular an electrochemical DC voltage source, having a multiplicity of partial voltage sources; wherein the simulation device comprises at least one simulation module, having
a module voltage source, which is configured to provide a module voltage at two external measurement points of the simulation module;
a voltage divider, which is configured to divide the module voltage into N−1 intermediate potentials at N−1 intermediate points, where N>1; and
N−1 operational amplifiers, which are configured to convert the N−1 intermediate potentials to N−1 partial potentials at N−1 internal measurement points of the simulation module; wherein the N−1 internal measurement points are surrounded by the two external measurement points in order to provide N partial voltages between N pairs of adjacent measurement points of the N+1 measurement points in order to simulate N partial voltage sources.

2. The simulation device according to claim 1, wherein
a positive input of an operational amplifier is coupled to an intermediate point; and
an output of the operational amplifier is coupled to an internal measurement point.

3. The simulation device according to claim 2, wherein the output of the operational amplifier is coupled to a negative input of the operational amplifier.

4. The simulation device according to claim 1, wherein
the voltage divider comprises a series circuit of N resistors;
the series circuit of N resistors is arranged in parallel with the module voltage source; and
an intermediate point corresponds to a contact point between two directly adjacent resistors of the N resistors.

5. The simulation device according to claim 1, wherein the voltage divider is configured to at least partly change the N−1 intermediate potentials.

6. The simulation device according to claim 1, wherein the N−1 operational amplifiers are supplied with electrical energy by way of the module voltage source.

7. The simulation device according to claim 1, wherein N>3.

8. The simulation device according to claim 1, wherein
the sum of the N partial voltages corresponds to the module voltage; and/or
a partial voltage lies in a voltage range between 0.5 V and 6 V.

9. The simulation device according to claim 1, wherein
the simulation device comprises at least two simulation modules, which are connected in series; and
two adjacent simulation modules are coupled to one another at a joint external measurement point.

10. The simulation device according to claim 2, wherein
the voltage divider comprises a series circuit of N resistors;
the series circuit of N resistors is arranged in parallel with the module voltage source; and
an intermediate point corresponds to a contact point between two directly adjacent resistors of the N resistors.

11. The simulation device according to claim 3, wherein
the voltage divider comprises a series circuit of N resistors;
the series circuit of N resistors is arranged in parallel with the module voltage source; and
an intermediate point corresponds to a contact point between two directly adjacent resistors of the N resistors.

12. The simulation device according to claim 2, wherein the voltage divider is configured to at least partly change the N−1 intermediate potentials.

13. The simulation device according to claim 3, wherein the voltage divider is configured to at least partly change the N−1 intermediate potentials.

14. The simulation device according to claim 4, wherein the voltage divider is configured to at least partly change the N−1 intermediate potentials.

15. The simulation device according to claim 2, wherein the N−1 operational amplifiers are supplied with electrical energy by way of the module voltage source.

16. The simulation device according to claim 3, wherein the N−1 operational amplifiers are supplied with electrical energy by way of the module voltage source.

17. The simulation device according to claim 4, wherein the N−1 operational amplifiers are supplied with electrical energy by way of the module voltage source.

18. The simulation device according to claim 2, wherein
the simulation device comprises at least two simulation modules, which are connected in series; and
two adjacent simulation modules are coupled to one another at a joint external measurement point.

19. The simulation device according to claim 3, wherein
the simulation device comprises at least two simulation modules, which are connected in series; and
two adjacent simulation modules are coupled to one another at a joint external measurement point.

20. A test arrangement for testing a monitoring unit for a DC voltage source, in particular an electrochemical DC voltage source; wherein the test arrangement comprises:
the monitoring unit, which is configured to monitor and/or to control a DC voltage source on the basis of a multiplicity of measurement voltages for a corresponding multiplicity of partial voltage sources of the DC voltage source;
a simulation device according to claim 1 for providing a multiplicity of partial voltages; and
lines, which are configured to provide the multiplicity of partial voltages to the monitoring unit.
